(19) United States
(12) Patent Application Publication
(10) Pub. No.: US 2007/0082974 A1
(43) Pub. Date: Apr. 12, 2007

(54) Friction material

(75) Inventors: Osao Ogiwara, Tokyo (JP); Satoshi Kusaka, Tokyo (JP); Noboru Noguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: AKEBONO BRAKE INDUSTRY CO., LTD.

(21) Appl. No.: 11/411,830

(22) Filed: Apr. 27, 2006

(30) Foreign Application Priority Data
Apr. 27, 2005 (JP) P 2005-130046

(51) Int. Cl. C08J 5/14

(52) U.S. Cl. 523/149; 524/495

(57) ABSTRACT

A friction material is provided with a baked carbonized organic material as the binder thereof. The friction material has a degree of compression deformation at room temperature of from 0.3 to 2.5% under a load of 4 MPa and from 1.0 to 4.5% under a load of 10 MPa. The compression deformation ratio of the degree of compression deformation at 300° C. to the degree of compression deformation at room temperature is from 1.0 to 1.5 under a load of from 1 to 10 MPa. The baking carbonization step comprises carbonizing an organic material in any atmosphere of vacuum, reducing gas or inert gas at a temperature of from 550° C. to 1300° C. with applying a load thereto.

The present application claims foreign priority based on Japanese Patent Application No. P. 2005-130046, filed on Apr. 27, 2005, the contents of which are incorporated herein by reference.

### BACKGROUND OF THE INVENTION

1. Field of the Invention

The present invention relates to a friction material for brake lining that is used in automobiles, railroad cars, airplanes, industrial machines, etc.

2. Related Art

From the viewpoint of energy-saving and efficiency, it is desired that brakes are small-sized and lightweight and have high quality. In addition, it is desired that a friction material for a brake lining has good heat resistance durable to high-temperature and high-load conditions.

The friction material essentially used in automobiles and railroad cars is formed of a thermosetting resin such as typically a phenolic resin serving as a binder. However, since the binder is an organic material, a friction factor at high speed may be low, a degree of compression deformation may increase owing to thermal deformation of softening of the organic material by a brake heat, and the friction factor may lower owing to a thermal decomposition of the material (the phenomenon may be referred to as “fading”).

With an increased demand for high-speed, high-capacity and energy-saving automobiles and railroad cars in these days, more small-sized and more lightweight brakes are much desired and the load to be applied to the friction material for these is increasing more and more.

To solve the problems, proposed are a slide member formed of a copper-based sintered alloy not using an organic material (see JP-A-07-102335); a rotor and a friction material formed of a C/C composite (carbon fibers-reinforced carbon composite) (see JP-B2-2805263 and JP-A-07-332414); and a rotor formed of a ceramic-matrix composite material (CMC) (see JP-A-04-347020).

However, the copper-based sintered alloy is problematic in that its heat resistance is limited to the melting point of the constitutive metal though it does not thermally decompose; and the C/C composite is also problematic in that its low-speed low-temperature friction coefficient is low and it is readily influenced by moisture or water though the rotor and the friction material formed of such a C/C composite could be lightweight and have a high friction factor at high speed and its has good friction characteristics such as good resistance to high-temperature compression deformation and good resistance to fading.

Other problems are that the friction characteristics of the composite to cast iron rotors that are generally used in ordinary road running are unstable, and, in addition, since its production is difficult, its cost is high, or that is, hundreds times that of ordinary products.

Briefly, a production method for C/C composites is as follows: A polymer material is applied to carbon fibers serving as a reinforcing material, and after shaped, this is baked and carbonized in a high-temperature carbonization furnace. However, when baked once, then the composite has a low density and could not have the intended strength. Accordingly, the step of polymer material application and baking must be repeated many times for carbonization to thereby increase the density of the composite.

When baked once, the composite may generally have a density of about 1.5 g/cm³, and its density is increased up to about 1.8 g/cm³ by repeated polymer material application and baking, and thereafter the composite is graphitized at a high temperature of 2000° C. or higher to produce a friction material. The entire process takes a few weeks to a few months, and this results in the increase in the cost of the friction material formed of the composite.

Another principal factor of such unstable friction capabilities of the friction material is that the contact condition thereof in friction could not be stable. In order to improve the contact condition of an organic friction material, the degree of compression deformation thereof is an important factor since the friction material deforms owing to the pressure applied thereto in braking with it and since its contact condition is thereby stabilized. The problem with the organic friction material in point of the degree of compression deformation thereof is that the organic material may fuse or decompose at a high temperature and the degree of high-temperature deformation thereof may increase too much, and, as a result, the organic material may have some negative influences such as abnormal friction or dragging. For these reasons, therefore, the organic friction material is limited in point of the degree of compression deformation thereof. On the other hand, the C/C composite friction material formed of an organic material alone may be free from the problems and may be significantly advantageous in point of the temperature condition around it, but it has a problem in that the degree of compression deformation thereof could not be significantly controlled while keeping its necessary friction strength, because of its constitutive component and its production method.

In addition, the principal cause why the composite could not be a high-density product in one baking operation may be because the fibers and the woven cloth used as a reinforcing material therein are stable carbon fibers that do not undergo a structural change in baking but the binder may shrink and reduce to about ½ in volume through carbonization of the polymer material constituting it (its carbonization degree is about 50%) and therefore the shrunk part may remain to be pores in the composite.

### SUMMARY OF THE INVENTION

One or more embodiments of the present invention provide a friction material which is free from the drawbacks of C/C composites that have a low friction factor at low speed and low temperature and are readily influenced by moisture and water, which may therefore exhibit stable properties even in friction to not only rotors of C/C composites or ceramic-based composites but also ordinary cast iron rotors generally used in ordinary road running, and which is inexpensive.

In accordance with one or more embodiments of the present invention, a friction material is provided with a baked carbonized organic material as the binder thereof. The friction material has a degree of compression deformation at room temperature of from 0.3 to 2.5% under a load of 4 MPa and from 1.0 to 4.5% under a load of 10 MPa.

Further, in accordance with one or more embodiments of the present invention, a compression deformation ratio of the degree of compression deformation at 300° C. to the degree of compression deformation at room temperature may fall within a range of from 1.0 to 1.5 under a load of from 4 to 10 MPa.

Further, in accordance with one or more embodiments of the present invention, a baking carbonization may provided with a steps of carbonizing the organic material in one of atmospheres of vacuum, reducing gas or inert gas at a temperature of from 550° C. to 1300° C. with applying a load thereto.

Further, in accordance with one or more embodiments of the present invention, a filling factor that indicates a ratio of a density of a shaped article to a true density of the shaping material of the friction material may fall within a range of from 65 to 85%.

Further, in accordance with one or more embodiments of the present invention, the friction material is provided with: from 3 to 30% by volume of an organic material to be the binder through baking carbonization thereof; from 10 to 40% by volume of an inorganic filler serving as a friction modifier; from 15 to 50% by volume of a solid lubricant; and from 5 to 35% by volume of a metal material.

Further, in accordance with one or more embodiments of the present invention, the organic material may provided with a polymer material of such that its carbonization yield for carbonization through baking is at least 50%.

Further, in accordance with one or more embodiments of the present invention, the polymer material may provided with one or more of pitch, meso-phase carbon, phenolic resin and copna resin.

Further, in accordance with one or more embodiments of the present invention, the solid lubricant may provided with one or more different types of granules or fibers of a carbonaceous material (e.g., carbon black) and/or a graphitic material (e.g., natural graphite, artificial graphite).

Further, in accordance with one or more embodiments of the present invention, the metal material may provided with one or more different types of granules or fibers of iron, stainless steel, copper, bronze, brass, aluminium and/or tin.

In accordance with one or more embodiments of the present invention, the friction material having the filling factor of from 65 to 85% is manufactured by baking and carbonization under a load of from 5 kPa to 3 MPa applied thereto.

According to one or more embodiments of the present invention, the friction material with controlled degree of compression deformation has a higher friction factor at high speed than comparative materials, and is more excellent in the fading resistance (resistance to reduction in the friction factor at high temperature), the speed spread capability and the G-spread capability, and has better heat resistance than that initially intended for it. Further, the degree of compression deformation of the friction material can be planned in a broader range and, in addition, the change in the compression deformation degree thereof is small and stable even at high temperature. Therefore, the degree of compression deformation of the friction material may be optimized so as to be suitable for every friction condition that may be applied to brakes for automobiles, railroad cars, airplanes, industrial machines, etc. Accordingly, the friction material may be effective for improving the safety of the brakes comprising it and may be expected to have good influences on the total planning of brakes and other systems that are to be small sized and lightweight.

Other aspects and advantages of the invention will be apparent from the following description and the appended claims.

### BRIEF DESCRIPTION OF THE DRAWINGS

FIG. 1 is a correlation diagram of HRR and compression deformation.

FIG. 2 is a correlation diagram of HRS and HRR.

FIG. 3 is a correlation diagram of compression deformation and HRS under a load of 8 MPa.

FIG. 4 is a correlation diagram of “filling factor and degree of compression deformation at room temperature” in Examples (1) to (15).

FIG. 5 is a graph showing the relationship of “degree of compression deformation and temperature” of the samples Nos. (1), (4), (8) and (13) and the comparative sample.

FIG. 6 is a graph showing the relationship of “degree of compression deformation and temperature” of the samples Nos. (1), (4), (8) and (13) and the comparative sample.

FIG. 7 is a graph showing the relationship of “degree of compression deformation and temperature” of the samples Nos. (1), (4), (8) and (13) and the comparative sample, indicating “change of degree of compression deformation at room temperature and high temperature”.

FIG. 8 is a graph showing “friction factor and its reduction (fade=1−fade m/initial m) of Examples (1) to (15) and Comparative Example.

FIG. 9 is a graph showing the change of friction factor in fading test of Examples Nos. (4), (8) and (13).

FIG. 10 is a graph showing the wear of Examples and Comparative Example.

FIG. 11 is a graph showing the deceleration-dependent friction factor in high-speed running test.

### DETAILED DESCRIPTION OF THE EXEMPLARY EMBODIMENTS

Exemplary embodiments of the invention will be described with reference to the accompanying drawings.

In a process of producing conventional C/C composites, there is a problem in controlling the friction characteristics and the degree of compression deformation in hybridizing metal and inorganic material. The reason is because, since the composition is repeatedly baked at a high temperature (2000° C. or higher), the metal and the organic material may fuse and flow out and may therefore readily decompose and sublime, and they could not be hybridized.

For solving the problem, a method has heretofore been investigated for carbonization and hybridization at low temperature (for example, Patent Reference 5, Patent Reference 6). In Examples of these references, a hardness (with a Rockwell hardness scale: HRS) is measured as a substitutive value for the degree of compressive deformation. In these, however, the materials could not have a satisfactory degree of compression deformation to be harder than conventional materials.

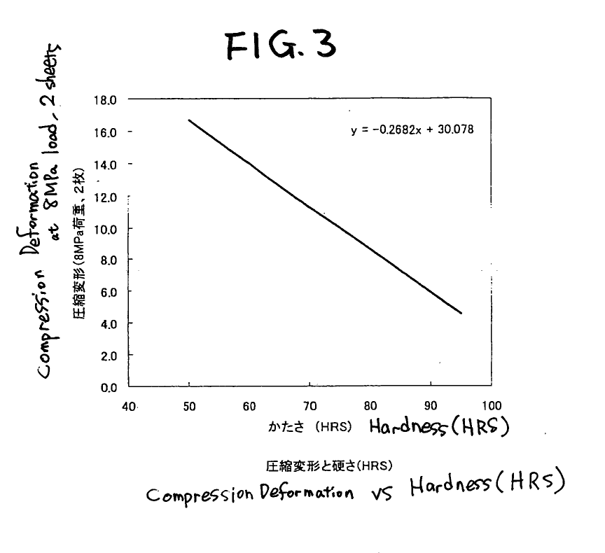

The detailed comparison with the prior-art technique is illustrated in FIG. 3 which shows a relationship between the hardness (HRS) and the compression deformation of a friction material that comprises baked carbon as the binder thereof. However, the inclination of a conventional friction material comprising a phenolic resin as the binder thereof changes since the elastic modulus thereof significantly differs.

In Rockwell hardness determination with an HRS scale, its detectable range is from 50 to 115 within which it can maintain its accuracy; and a soft material of which the hardness is lower than the lowermost detection limit with the HRS scale must be measured with an HRR scale.

Accordingly, the material of this exemplary embodiment of the present invention was measured with a precision Rockwell hardness HRR scale.

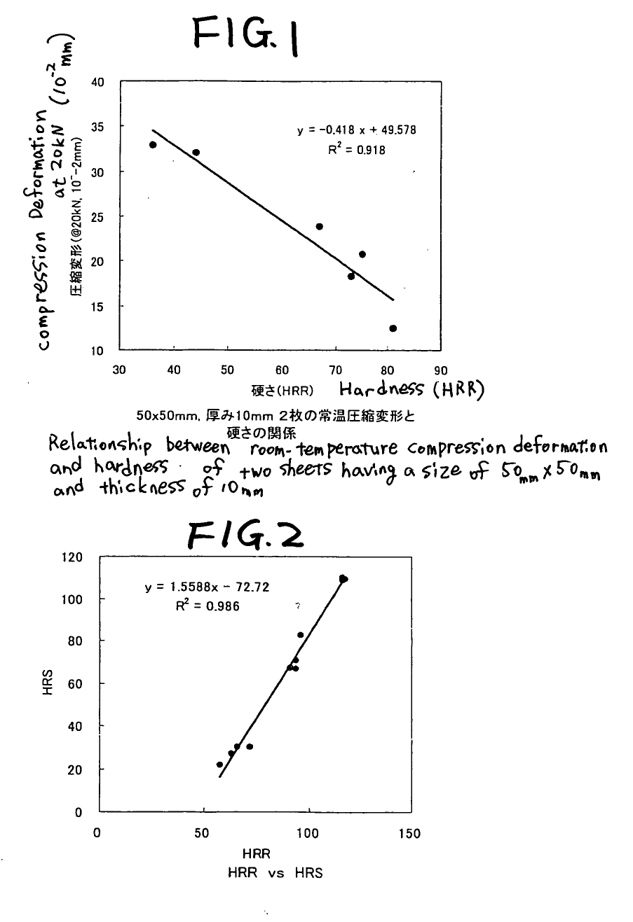

Based on the thus-measured data, a correlation diagram between the hardness and the degree of compression deformation under a load of 8 MPa was drawn (see FIG. 3). Next, based on the correlation between HRS and HRR (see FIG. 2), a correlation diagram between HRR and compression deformation (see FIG. 1) was drawn.

In JP-B2-2601652, the hardness HRS of the conventional material is from 65 to 70, and the degree of compression deformation of a general friction material having a hardness to fall within the range is from 20 to 30×10⁻² mm; while, on the other hand, the hardness HRS of the material of the invention is from 75 to 83 and the degree of compression deformation thereof is at most 8×10⁻² mm, as in FIG. 1, and is small.

In addition, it is at most ½ of the degree of compression deformation, from 19 to 77×10⁻² mm, of the materials of the invention, and it is understood that its contact in braking with it is poor. In Example 1 in the above-mentioned Patent Reference 5, an organic pad comprising bulk meso-phase carbon (BMC) as the binder thereof is shaped at a temperature of from 400° C. to 650° C. and under a load of from 100 to 700 kg/cm². In this, however, since the binder is BMC alone, the flowability of the composition is poor in its shaping, and therefore the composition would require a high load of at least 10 MPa for its shaping.

Also in Example 2 in JP-B2-2601652, the hardness HRS of the conventional semi-metallic pad material is from 72 to 78. Relative to the degree of compression deformation, from 10 to 15×10⁻² mm, of ordinary semi-metallic material having a hardness within the range, the material having HRS of from 80 to 90 has a small degree of compression deformation, at most 8.9×10⁻² mm, as in FIG. 3, and this could not be a degree of compression deformation enough to ensure good contact condition. As in FIGS. 1 and 2 in JP-B2-2601652, the material in the Example showed better results at a temperature not higher than 500° C. than conventional materials, but no data are given regarding the result of the material at a temperature higher than that temperature.

Disclosed in JP-A-63-310770 6 is a friction material comprising BMC as the binder thereof and containing steel fibers, and this is shaped as in JP-B2-2601652, and then this is processed in a hydrogen atmosphere at 1050 to 1150° C. for 10 to 40 minutes whereby the surface of the steel fiber therein is carburized and integrated with carbon, and accordingly, the thus-processed friction material is thereby reinforced. However, the reference says nothing about the increase in the degree of compression deformation of the material and about the improvement of the contact condition of the material.

These studies are continued, but no one has as yet succeeded in improving an inorganic material over conventional organic friction materials in point of the contact condition thereof so that the inorganicmaterial couldbe stable at high temperature, and the development of the inorganic material is not as yet on a practicable level.

This embodiment of the present invention is to provide a stable friction material at low costs. Concretely, the carbonization is attained once at a low temperature for a short period of time, and the degree of compression deformation of the friction material, which is an important factor for improving the stability of the friction characteristics of the material, is enlarged over conventional organic friction materials by combination of a hybridization technique and a baking carbonization technique. As a result, the friction material of the invention thus obtained may have a stable capability even under a high-load condition.

The baking carbonization process for the friction material of the invention comprises heating an organic material in any atmosphere of vacuum, reducing gas or inert gas with applying the necessary load thereto, up to a temperature at which the organic material may carbonize (at least about 550° C.), and keeping it under condition. The material to be used herein for the hybridization may be selected principally from those that have heretofore been practically commercialized for organic friction materials, but in principle, it is selected from those that hardly undergo fusion or decomposition or undergo any other chemical reaction such as synthesis or sublimation under the baking and carbonization condition employed herein.

The hybridizing composition to constitute the friction material of this embodiment of the invention may comprise from 3 to 30% by volume of an organic material that is to be a binder through baking and carbonization, from 10 to 40% by volume of an inorganic filler that serves as a friction modifier for controlling the friction characteristics such the friction factor and the wear resistance of the material, from 15 to 50% by volume of a solid lubricant and from 5 to 35% by volume of a metal material. In this, the constitutive components and their blend ratio may be varied in consideration of the physical and chemical reaction of the inorganic filler, the solid lubricant and the metal material in the composition that may occur against the opposite object to which the friction material is rubbed during its use.

The organic material for use in this embodiment of the invention is preferably a polymer material having a carbonization yield of at least 50% in order to obtain a high-density and high-strength product in one baking operation. For it, for example, preferred is an easily-carbonizing material such as pitch, meso-phase carbon, phenolic resin, copna resin.

For the technique of controlling the physical properties important for the friction material, especially controlling the degree of compression deformation and the strength of the friction material, a plurality of such different organic materials may be combined, or the other factors such as the heating speed in baking, the baking temperature, the carbonization time and the load may be combined.

The inorganic filler used as the friction modifier in this embodiment of the invention may be a mineral or clay material including, for example, calcium carbonate, barium sulfate, alumina, silicon carbide, magnesium oxide, mullite, silimanite, andalusite, zirconia, zirconsand, potassium titanate, apatite, talc (ferripyrophylite), kaolin, glauconite, foamed vermiculite, pearlite, chlorite.

The solid lubricant may be a carbonaceous material (e.g., carbon black), or a graphitic material (e.g., natural graphite, artificial graphite).

The metal material may be, for example, iron, stainless steel, copper, bronze, brass, aluminium, tin. In actual use thereof, a plurality of these materials may be combined in consideration of their shape or size such as powdery, granular or fibrous forms. Their combination must be determined further in consideration of the influence of their interaction to be caused by the friction heat during their friction, such as oxidation, reduction, decomposition, recrystallization or other phenomena.

For the friction material of this embodiment of the invention an organicmaterial is carbonized at its carbonization temperature of 550° C. or higher, in an reducing gas or inert gas atmosphere or in vacuum. The carbonization atmosphere and condition must be determined so that the carbonization yield of the material may be high and the constitutive components may hardly fuse and flow away or may hardly undergo chemical reaction under the determined condition. For example, when an aluminium metal is in the composition to be carbonized, then the baking temperature is preferably about 600° C.; or when copper or its alloy is therein, it is preferably from 800° C. to 1000° C.; or when an iron-based metal is therein, it is preferably from 1000° C. to 1300° C. Since the baking carbonization temperature may have significant influences on the environment, the energy-saving requirement and the production cost, it is preferably as low as possible for low-temperature baking and carbonization to attain the intended friction capability.

The baking carbonization process may be carried out in any method of indirect heating for heating carbonization in a carbonization furnace, or direct heating by electric current application to the composition to be carbonized, and the intended carbonization may be attained in any of those methods. Further, for shaping it, the shaping material may be directly put into a mold and it may be baked and carbonized under load therein, or may be previously cold-shaped under high pressure and then baked and carbonized.

In order that a brake may keep a stable capability, the friction material must be suitably deformed by the pressure applied to it in braking, and must keep a stable contact condition within a broad temperature range. We, the present inventors have assiduously studied in order that the friction material of the invention may have an increased degree of deformation under pressure and may keep a good contact condition, and, as a result, have found that, when the filling factor of the baked and carbonized composite material is varied, then the degree of compression deformation of the material may be controlled, and, as a result, have succeeded in providing a friction material that has a degree of compression deformation of the same level as that of organic friction materials now available on the market and practicable in the art. In general, the filling factor of a friction material is controlled by varying the load to be applied to the material during its baking and carbonization process, but when the material is shaped in a mold, it may also be possible to fill a mold with a predetermined amount of the material and to bake and carbonize it for volume control therein.

The filling factor of the friction material of this embodiment of the invention is defined to fall from 65% to 85%, and two test pieces having a size of 50 mm×50 mm and a thickness of 10 mm are put one upon another at room temperature. When they are pressed under a pressure load of 20 kN, then the degree of compression deformation thereof is from 10 to 80×10² mm; and when this is converted into a degree of change. of the thickness of the two test pieces, then the degree of change thereof under a load condition of about 8 MPa is from about 0.5 to 4% (JIS D4413), and this proves the possibility of broad-range planning of the friction material.

Regarding the stability of friction properties of a friction material, it is well known that the degree of compression deformation of a friction material is as large as possible within a range within which the friction material does not cause any abnormal change such as breakage or abnormal wear during friction. Depending on its use, however, the friction material maybe limited by a system comprising it. For example, the friction material for automobiles is desired to have a small degree of compression deformation, but for the friction material for railroad cars, the degree of compression deformation is not a matter of importance.

In this embodiment of the invention, the degree of compression deformation of the friction material maybe planned within a broad range, and therefore it is possible to plan the contact condition of the friction material so as to be most favorable for the brakes in automobiles, railroad cars, industrial machines and airplanes within the limited condition range for them.

At high temperature (300° C. or higher), the organic friction material now actually used in the art may be softened or thermally deformed or decomposed and therefore the degree of compression deformation thereof may significantly vary. However, the friction material of this embodiment of the invention is baked at high temperature not lower than 550° C., and therefore the organic material therein is carbonized and hybridized to give an inorganic composite material. Accordingly, the friction material of the invention changes little, depending on the ambient temperature change. When the change in the degree of compression deformation at room temperature and at a high temperature (300° C.) is considered as the degree of change thereof, then the degree of change of the organic friction material is at least about 2 times, but that of the friction material of the invention is at most 1.5 times and is small. This confirms that the stability of the friction material of the invention at high temperature (FIG. 7) is good.

Though varying depending on the composition to be baked and on the baking method employed, we, the inventors have clarified that the pressure load to be applied to the composition being baked may be from about 5 to 10 kPa in a load control method in order that the filling factor could be around 65% in a load control method, or may be from about 2 to 3 MPa in order that the filling factor could be around 85%.

### EXAMPLES

The baking carbonization in this experiment was carried out according to a heating carbonization method of using an ordinary carbonization furnace in which the carbonizing material is heated and carbonized in nitrogen gas, or according to a vacuum heating carbonization method of suing a commercially-available discharge plasma sintering machine.

[Preliminary Experiment]

Samples of a carbonized composite friction material were produced as follows: A composition to be carbonized was kept in nitrogen gas at a baking temperature of 900° C. for 1 hour, and then a sample of 50 mm×50 mm in size was pressed under a load of from 2.5 kN to 30 kN. In this stage, the degree of compression deformation necessary for the friction material was controlled by varying the filling factor.

Before the experiment, the range of the uppermost and the lower most filling factor was estimated in a preliminary experiment. Briefly, a filling factor range of from 61% to 88% was divided at regular intervals of about 5%, and at every filling factor thus divided, samples were produced and tested in a simple test. The simple test is the first fading test of “Test Code (1)”, and the results are given in Table 1.

TABLE 1
Preliminary Experiment Results

| | | Preliminary Experiment No. | | | | | | |
|---|---|---|---|---|---|---|---|---|
| | | Pre1 | Pre2 | Pre3 | Pre4 | Pre5 | Pre6 | Pre7 |
| Component | Material | | | | | | | |
| Organic | pitch + phenolic | 15 | 15 | 15 | 15 | 15 | 15 | 15 |
| Material | resin | | | | | | | |
| Inorganic | alumina | 2 | 2 | 2 | 2 | 2 | 2 | 2 |
| Filler | magnesium oxide | 38 | 38 | 38 | 38 | 38 | 38 | 38 |
| Solid | artificial | 35 | 35 | 35 | 35 | 35 | 35 | 35 |
| Lubricant | graphite | | | | | | | |
| Metal | copper powder | 10 | 10 | 10 | 10 | 10 | 10 | 10 |
| | total | 100 | 100 | 100 | 100 | 100 | 100 | 100 |
| Production Condition, Physical | | | | | | | | |
| Properties, Evaluation | | | | | | | | |
| Physical | face pressure in | 0.7 | 1 | 1.5 | 2 | 3 | 4.5 | 5.5 |
| Properties | pre-shaping (MPa) | | | | | | | |
| | load in baking | 0.1 | 0.15 | 0.75 | 15 | 15 | 15 | 30 |
| | (MPa) | | | | | | | |
| | filling factor | 61 | 65 | 71 | 76 | 79 | 85 | 88 |
| Fading Test | pad deformation | C | A | A | A | A | A | A |
| | or abnormal wear | | | | | | | |
| | deposition on the | A | A | A | A | A | B | C |
| | opposite object | | | | | | | |

A: Neither pad deformation nor abnormal wear found, No deposition found on the opposite object.
B: Some deposition found on the opposite object, but it is negligible in practical use.
C: Pad deformation and abnormal wear found, Much deposition found on the opposite object.

Table 1 shows that, in the preliminary experiment No. 1 where the filling factor is 61%, the wear of the friction factor is abnormally large, and the edges of the test piece were broken and the sample is impracticable in point of its strength. In the preliminary experiment No. 2 where the filling factor is 65%, the wear is small and the deposition is also small, and the test results were good. On the other hand, in the preliminary experiment No. 7 where the filling factor is 88%, the wear resistance is good, but after repeated friction, there occurred frictional vibration and the test was stopped as it was difficult to continue the test.

After the test, the rotor was checked, and much deposition thereon was found. Since the compression deformation of the friction factor was small and therefore the contact condition thereof in braking was not good, and, as a result, the cohesion force was great in the high-temperature part that received the friction heat, and this would result in the frictional vibration.

In the preliminary experiment No. 6 where the filling factor is 85%, there also occurred frictional vibration, but it was very small and cause no trouble in continuing the test. This means the sample has no problem in its practical use.

From the results of the preliminary experiment, the filling factor is defined to fall within a range of from 65 to 85% within which the friction material may keep its good contact condition. In the following Examples, the filling factor falls within the defined range.

[Experiment]

In this experiment, the filling factor is from 65 to 85% in Examples (1) to (5), and is from 70 to 80% in Examples (6) to (15). Within the range, the following samples were produced and tested.

[Test Matters of Samples]

Physical properties: filling factor, compression deformation (test condition: size 50 mm×50 mm, thickness 10 mm, test method: JIS D4413, room temperature, 300° C.). Friction characteristics: fading, wear, high-speed capability.

### Examples (1) to (5)

Phenolic resin and pitch as an organic material having a high carbonization yield; copper powder as a metal; artificial graphite as a lubricant; and fused magnesium oxide and alumina as an inorganic filler were mixed and baked and carbonized in an ordinary carbonization furnace.

TABLE 2
Examples (1) to (5) and Comparative Example

| | | | | | | | Comparative |
|---|---|---|---|---|---|---|---|
| | | | | | | | Example |
| | | Example No. | | | | | domestic |
| | | (1) | (2) | (3) | (4) | (5) | material |
| Component | Material | | | | | | |
| Organic | phenolic resin + | 3 | 7 | 10 | 15 | 20 | |
| Material | pitch | | | | | | |
| Inorganic | alumina | 2 | 2 | 5 | 2 | 2 | |
| Filler | magnesium oxide | 40 | 38 | 10 | 38 | 33 | |
| Solid Lubricant | artificial | 45 | 23 | 50 | 35 | 15 | |
| | graphite | | | | | | |
| Metal Powder | Copper powder | 10 | 30 | 25 | 10 | 30 | |
| Total | total | 100 | 100 | 100 | 100 | 100 | |
| Physical Properties, | | | | | | | |
| Friction Characteristics | | | | | | | |
| Physical | filling factor (%) | 65 | 72 | 73 | 75 | 85 | 85 |
| Properties | compression | 76.8 | 42 | 34 | 31.1 | 18.8 | 28 |
| (average) | deformation, room | | | | | | |
| | temperature (load | | | | | | |
| | 8 MPa, unit 10⁻² mm) | | | | | | |
| | compression | 99.9 | 52 | 41 | 41.9 | 22.9 | 63 |
| | deformation, high | | | | | | |
| | temperature (load | | | | | | |
| | 8 MPa, unit 10⁻² mm) | | | | | | |
| | compression | 1.30 | 1.24 | 1.21 | 1.35 | 1.22 | 2.25 |
| | deformation change | | | | | | |
| | (high temperature/ | | | | | | |
| | room temperature) | | | | | | |
| Friction | initial μ | 0.41 | 0.42 | 0.39 | 0.45 | 0.39 | 0.31 |
| Characteristics | highest μ | 0.41 | 0.42 | 0.44 | 0.45 | 0.43 | 0.31 |
| | faded μ | 0.37 | 0.38 | 0.36 | 0.37 | 0.35 | 0.22 |
| | fading ratio (%) | 9.8 | 9.5 | 7.7 | 17.8 | 10.3 | 29.0 |
| | Wear (mm) | 1.3 | 0.8 | 0.6 | 0.8 | 0.5 | 2.3 |

The condition for baking, carbonization and shaping was as follows: In nitrogen gas, the composition was kept at a baking carbonization temperature of 900° C. under a load of from 5 kPa to 3 MPa for 1 hour, and the load was defined so that the filling factor could be from 65 to 85%.

### Examples (6) to (10)

Phenolic resin and pitch as an organic material having a high carbonization yield; iron powder as a metal material; artificial graphite as a lubricant; and alumina, fused magnesium oxide and foamed vermiculite as an inorganic filler were mixed and baked and carbonized, using a discharge plasma sintering machine.

TABLE 3
Examples (6) to (10)

| | | Example No. | | | | |
|---|---|---|---|---|---|---|
| | | (6) | (7) | (8) | (9) | (10) |
| Component | Material | | | | | |
| Organic | phenolic resin + | 10 | 15 | 20 | 25 | 20 |
| Material | pitch | | | | | |
| Inorganic | alumina | 2 | 2 | 2 | 2 | 2 |
| Filler | foamed | 25 | 20 | 20 | 13 | 5 |
| | vermiculite | | | | | |
| | magnesium oxide | 10 | 10 | 10 | 10 | 5 |
| Solid Lubricant | artificial | 33 | 23 | 23 | 15 | 36 |
| | graphite | | | | | |
| Metal Powder | iron powder | 20 | 30 | 25 | 35 | 32 |
| Total | total | 100 | 100 | 100 | 100 | 100 |
| Physical Properties, | | | | | | |
| Friction Characteristics | | | | | | |
| Physical | filling factor (%) | 74 | 76 | 77 | 78 | 78 |
| Properties | compression | 35 | 27 | 35.9 | 26 | 18 |
| (average) | deformation, room | | | | | |
| | temperature (load | | | | | |
| | 8 MPa, unit 10⁻² mm) | | | | | |
| | compression | 44 | 33 | 40.4 | 30 | 21 |
| | deformation, high | | | | | |
| | temperature (load | | | | | |
| | 8 MPa, unit 10⁻² mm) | | | | | |
| | compression | 1.26 | 1.22 | 1.13 | 1.15 | 1.17 |
| | deformation change | | | | | |
| | (high temperature/ | | | | | |
| | room temperature) | | | | | |
| Friction | initial μ | 0.39 | 0.45 | 0.45 | 0.47 | 0.38 |
| Characteristics | highest μ | 0.39 | 0.45 | 0.55 | 0.47 | 0.38 |
| | faded μ | 0.35 | 0.38 | 0.374 | 0.41 | 0.35 |
| | fading ratio (%) | 10.3 | 15.6 | 16.9 | 12.8 | 7.9 |
| | wear (mm) | 0.8 | 1.3 | 1.2 | 1.5 | 0.9 |

The condition for baking, carbonization and shaping was as follows: In vacuum, the composition was kept at a carbonization temperature of 1000° C. under a load of from 1 MPa to 3 MPa for 5 minutes, and the load was defined so that the filling factor could be from 70 to 80%.

### Examples (11) to (15)

Phenolic resin and pitch as an organic material having a high carbonization yield; copper powder and aluminium powder as a metal material; artificial graphite as a lubricant; and fused magnesium oxide and alumina as an inorganic filler were mixed, baked and carbonized.

TABLE 4
Examples (11) to (15)

| | | Example No. | | | | |
|---|---|---|---|---|---|---|
| | | (11) | (12) | (13) | (14) | (15) |
| Component | Material | | | | | |
| Organic | phenolic resin + | 15 | 20 | 25 | 30 | 20 |
| Material | pitch | | | | | |
| Inorganic | alumina | 2 | 2 | 2 | 2 | 2 |
| Filler | | | | | | |
| | magnesium oxide | 38 | 28 | 18 | 28 | 8 |
| Solid Lubricant | artificial | 20 | 15 | 25 | 15 | 35 |
| | graphite | | | | | |
| Metal Powder | aluminium powder | 5 | 5 | 5 | 5 | 5 |
| | copper powder | 20 | 30 | 25 | 20 | 30 |
| Total | total | 100 | 100 | 100 | 100 | 100 |
| Physical Properties, | | | | | | |
| Friction Characteristics | | | | | | |
| Physical | filling factor (%) | 70 | 73 | 75 | 74 | 73 |
| Properties | compression | 25 | 24 | 27.5 | 29 | 41 |
| (average) | deformation, room | | | | | |
| | temperature (load | | | | | |
| | 8 MPa, unit 10⁻² mm) | | | | | |
| | compression | 29 | 29 | 30.2 | 35 | 51 |
| | deformation, high | | | | | |
| | temperature (load | | | | | |
| | 8 MPa, unit 10⁻² mm) | | | | | |
| | compression | 1.16 | 1.21 | 1.10 | 1.21 | 1.24 |
| | deformation change | | | | | |
| | (high temperature/ | | | | | |
| | room temperature) | | | | | |
| Friction | initial μ | 0.41 | 0.44 | 0.42 | 0.45 | 0.38 |
| Characteristics | highest μ | 0.41 | 0.44 | 0.41 | 0.45 | 0.38 |
| | faded μ | 0.35 | 0.36 | 0.31 | 0.34 | 0.33 |
| | fading ratio (%) | 14.6 | 18.2 | 26.2 | 24.4 | 13.2 |
| | wear (mm) | 1.7 | 1.6 | 1.3 | 1.5 | 0.9 |

The condition for baking, carbonization and shaping was as follows: In nitrogen gas, the composition was kept at a carbonization temperature of 600° C. under a load of from 1 MPa to 3 MPa for 5 minutes, and the load was defined so that the filling factor could be from 70 to 80%.

[Friction Tester]

As a friction tester, used was a small-size test piece tester corresponding to 1/10 of a vehicle having an overall weight of 2000 kg. For clarifying the significant difference in the characteristics of a test piece, the friction load was defined under a sever condition, and was about 1.6 times that of an ordinary car (energy loading: in an ordinary car, it is about 540 N·m/cm²·s; but in this test, it is about 880 N·m/cm²·s), and the test piece was tested according to “Test Code (1)” essentially for fading resistance thereof and according to “Test Code (2)” essentially for the high-speed capability thereof.

[Tester Condition]

Inertia: 0.9 kgm²
Rotor size: 88φ
Friction material size: 13 mm×35 mm
   Test Code:
Test Code (1): fading test
Test Code (2): high-speed running test
   [Test Code (1): Fading Test]
Running-in:
   Initial speed: 65 km/h
   Deceleration: 0.3 G
   Initial temperature: 120° C.
Fading test:
   Initial speed 130 km/h→stop
   Deceleration: 0.4 G, constant output test
   Rotor material: FC250
Brake start temperature: 65° C.
   Brake interval; 35 sec
   Brake frequency:
      First fading 10 times
      Second fading 15 times
   Data analysis: first fading test
   Wear determination: second fading test
   Rotor temperature at 15th braking: 800° C. or higher
      [Test Code (2): High-Speed Running Test]
Running-in:
   Initial speed: 65 km/h
   Deceleration: 0.3 G
   Initial temperature: 120° C.
High-speed running test:
   Initial speed 130 km/h→stop
   Initial temperature: 95° C.
   Deceleration: 0.15 G to 0.75 G, constant output test
   Rotor material: FC250
      [Test Results]
      [Physical Data]
      (1) Filling Factor and Degree of Compression Deformation:

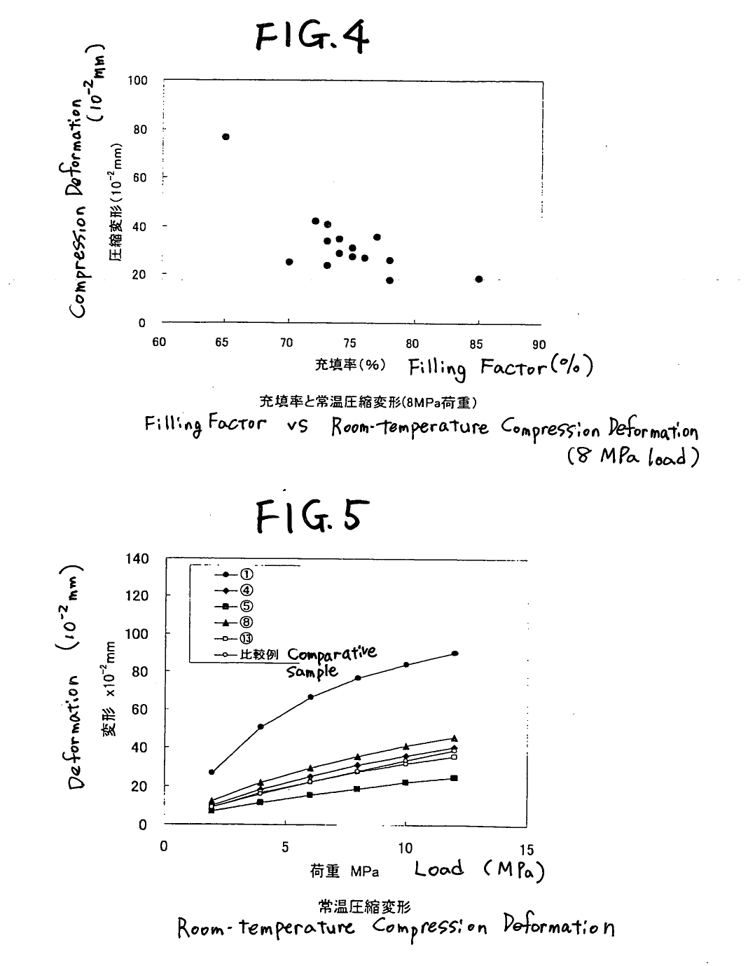

FIG. 4 shows a relation of “filling factor and degree of compression deformation at room temperature” in Examples (1) to (15). FIG. 4 indicates that, even though the type, the amount and the baking temperature of the friction modifier are changed, there still exists a predetermined relationship between the compression deformation and the filling factor, and that the degree of compression deformation necessary for friction may be controlled by changing the filling factor.

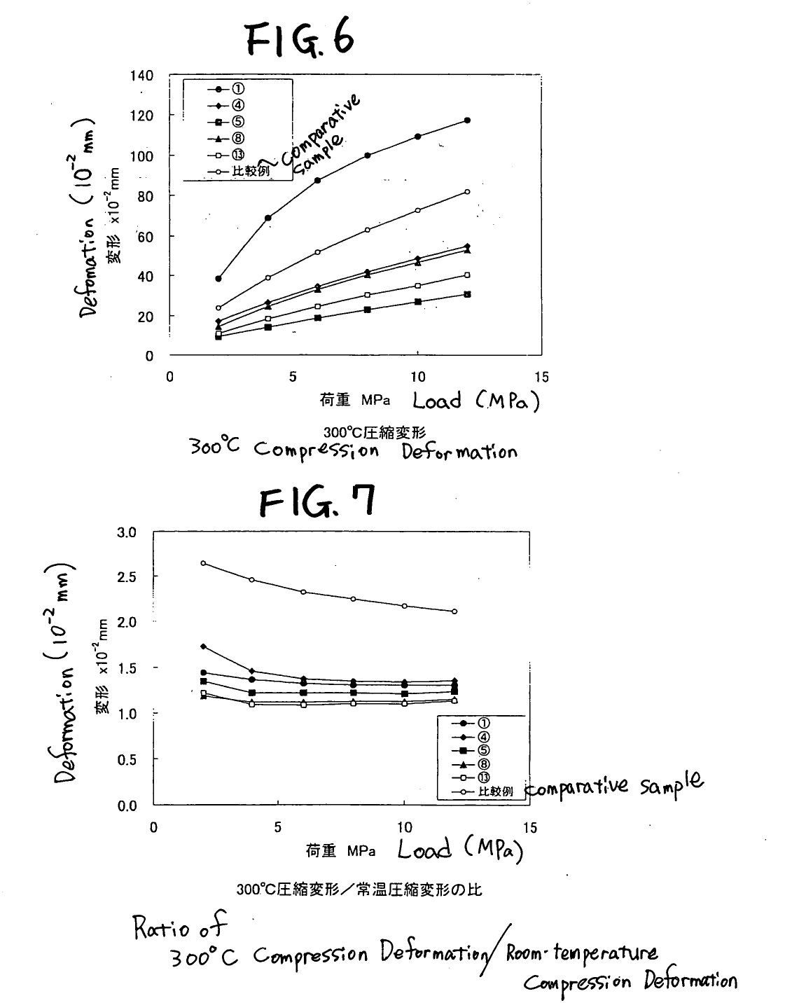

FIGS. 5, 6 and 7 show a comparison of samples Nos. (1), (4), (8) and (13) with a comparative sample in point of the relationship of “degree of compression deformation and temperature” therebetween. FIGS. 5 and 6 show the degree of compression deformation at room temperature and at a high temperature (sample temperature 300° C.), indicating that the data of all the samples except the sample No. (1) are equivalent to those of the comparative sample at room temperature.

In addition, these indicate that the degree of compression deformation of the sample No. (1) is especially large, therefore indicating the possibility of broad-range planning of friction materials in the invention. At high temperature, all the samples except the sample No. (1) did not greatly deform over the comparative sample, and this means that the samples of the invention are practicable at high temperature (that is, under severe friction condition).

FIG. 7 shows “change of degree of compression deformation at room temperature and high temperature”. As in FIG. 2, the change of the comparative sample is at least 2 times, while that of the samples of the invention is at most 1.5 times. This means that the characteristics of the samples of the invention are stable against the ambient temperature change.

[Friction Test]

(1) Test Code (1) (Fading Test):

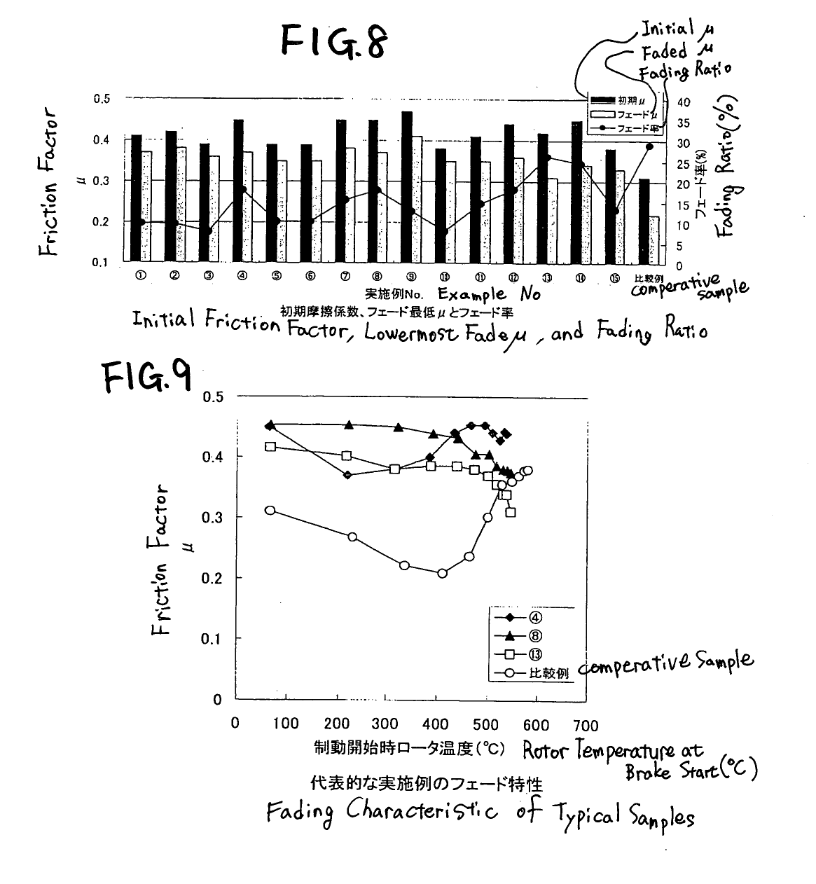

FIG. 8 shows “friction factor and its reduction (fade=1−faded μ/initial μ)” of Examples (1) to (15) and Comparative Example.

The samples of the invention have a friction factor of at least 0.35 and keep its friction factor of at least 0.30 even after faded; while the comparative sample has a friction factor of 0.31 and its friction factor decreased to 0.22 after faded. Thus, the samples of the invention are highly stable of the comparative sample. Regarding the reduction in the friction factor, the samples Nos. (13) and (14) had a some what large reduction of from 25 to 26%, but the reduction in the other samples is at most 20% and is much smaller than that in the comparative sample of 29%. This confirms that the samples of the invention are hardly faded.

FIG. 9 shows a change of the friction factor of the samples Nos. (4), (8) and (13) in the fading test.

The relation between the sample fading and the ambient temperature is investigated in point of the heat resistance of the samples, and it is understood that even the sample No. (13) of the invention that had faded most seriously reduced by 10% or so at around 400° C., and its heat resistance is much better than that of the comparative sample having reduced by 29%.

The friction factor of all the samples of the invention tends to lower with the increase in the ambient temperature, but the friction factor of the comparative sample became lowest during the test and then tends to increase thereafter. Thus, the characteristic of the samples of the invention differs from that of the comparative sample. The characteristic of the comparative sample is owing to lubrication with the liquid or vapor formed through decomposition of the organic material. In other words, in the comparative sample, when the organic material decomposed and disappeared and when the residue constitution became inorganic, then its fading factor again increased. This is characteristic of organic friction materials. Since the samples of the invention reduce their fading and since they are originally composed of only inorganic components, they are free from the problem of the comparative sample and may attain the intended object.

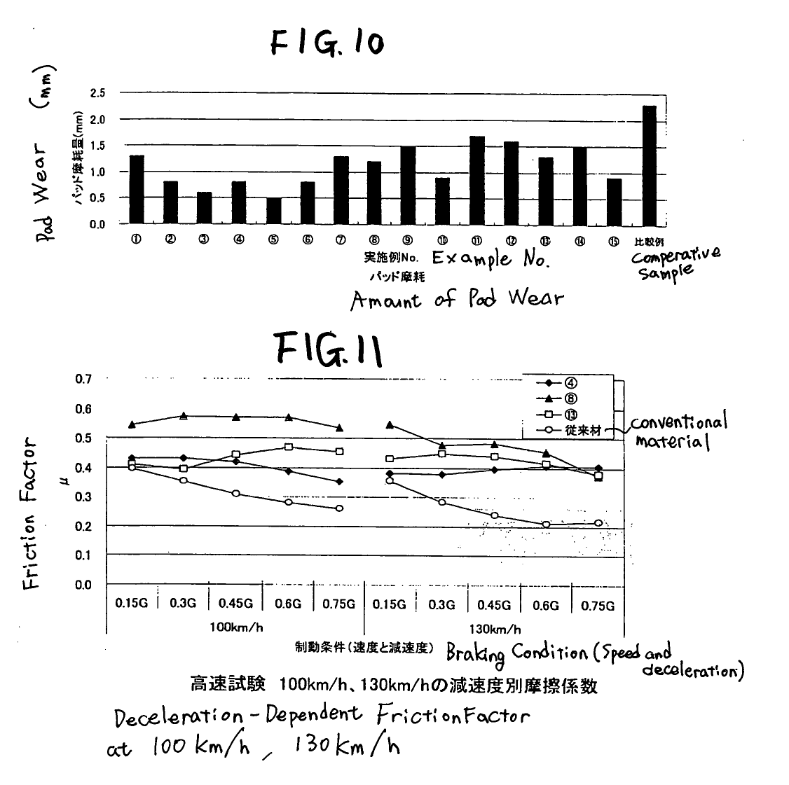

FIG. 10 shows the wear of the samples of the invention and the comparative sample, indicating that the wear of all the samples of the invention is smaller than that of the comparative sample. This confirms good wear resistance of the samples of the invention.

(2) Test Code (2) (High-Speed Capability):

The high-speed running test was carried out under a severer condition than ordinary (1.6 times that of car) for obtaining the significant difference in point of the high-speed friction factor, speed spread and G spread of the tested samples. FIG. 11 shows the results of the samples Nos. (4), (8) and (13) and the comparative sample typically selected from the samples in Tables 2, 3 and 4, in terms of the mean friction factor thereof at every deceleration (0.15 G, 0.35 G, 0.45 G, 0.6 G, 0.75 G).

In FIG. 11, the friction factor, the speed spread and the G spread that are important friction characteristics of the friction material samples are investigated.

[Friction Factor]

The friction factor of the comparative sample at a deceleration of 0.45 G and an initial speed of 100 km/h was 0.31 while that of the samples of the invention was from 0.42 to 0.56; the friction factor of the comparative sample at an initial speed was 0.20 while that of the samples of the invention was from 0.4 to 0.48. Thus, the friction factor of the samples of the invention is high and stable.

[Speed Spread (Brake Initial Speed and Friction Factor)]

The speed spread of the comparative sample at a deceleration of 0.45 G and an initial speed of 100 km/h and 130 km/h ((friction factor at 130 km/h/friction factor at 100 km/h)×100) was 65%, while that of the samples of the invention was from 85 to 102%. This means that the friction factor of the samples of the invention does not lower even at high-speed running, and is stable relative to running speed.

[G Spread (Deceleration and Friction Factor)]

The G spread of the comparative sample at a brake initial speed of 100 km/h ((friction factor at 0.75 G/friction factor at 0.15 G)×100) was 65%, while that of the samples of the invention was from 85 to 109% and was high. Further, the G spread of the comparative sample at a brake initial speed of 130 km/h was 57%, while that of the samples of the invention was from 68 to 108% and was high. This confirms that the deceleration-dependent change of the friction factor of the samples of the invention is small and stable.

The above results indicate that the high-speed friction factor of the friction material samples of the invention is stable.

As demonstrated in the Examples as above, the friction material samples of the invention are controlled in point of the degree of compression deformation thereof, and, when compared with that of the comparative sample, the high-speed friction factor of the samples of the invention is high and the samples of the invention are excellent in the fading resistance (reduction in the friction factor at high temperature), the speed spread and the G spread. Accordingly, the friction material of the invention satisfies the intended heat resistance. In addition, the friction material of the invention has a broad latitude in planning the degree of compression deformation thereof, and further, the change of the degree of compression deformation of the friction material of the invention is small and stable even at high temperature. Accordingly, the friction material of the invention may have an optimum degree of deformation applicable to any and every friction condition that may be used in brakes of automobiles, railroad cars, airplanes, industrial machines and others, and therefore it ensures improved safety braking with it. The present invention may be significantly expected for further improving more small-sized and lightweight brakes and their entire system planning.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A friction material comprising a binder made by baking and carbonizing organic material, wherein a degree of compression deformation at room temperature of the friction material is within a range from 0.3 to 2.5% under a load of 4 MPa and within a range from 1.0 to 4.5% under a load of 10 MPa.

2. The friction material according to claim 1, wherein a ratio of a degree of compression deformation at 300° C. to the degree of compression deformation at room temperature is within a range of from 1.0 to 1.5 under a load of from 4 to 10 MPa.

3. The friction material according to claim 1, wherein the organic material is baked and carbonized in one of atmospheres of vacuum, reducing gas and inert gas, at a temperature of from 550° C. to 1300° C. with applying a load to the organic material.

4. The friction material according to claim 1, wherein a filling factor is within a range of from 65 to 85%, wherein the filling factor indicates a ratio of a density of a shaped article to a true density of a shaping material.

5. The friction material according to claim 1, wherein a shaping material to be the friction material by baking and carbonizing includes:
from 3 to 30% by volume of an organic material to be the binder through baking carbonization;
from 10 to 40% by volume of an inorganic filler serving as a friction modifier;
from 15 to 50% by volume of a solid lubricant; and
from 5 to 35% by volume of a metal material.

6. The friction material according to claim 5, wherein the organic material comprises a polymer material having a carbonization yield for carbonization through baking is at least 50%.

7. The friction material according to claim 6, wherein the polymer material comprises at least one of pitch, meso-phase carbon, phenolic resin and copna resin.

8. The friction material according to claim 5, wherein the solid lubricant comprises granules or fibers of at least one of a carbonaceous material and a graphitic material.

9. The friction material according to claim 5, wherein the metal material comprises granules or fibers of at least one of iron, stainless steel, copper, bronze, brass, aluminium and tin.

10. The friction material according to claim 4, wherein the friction material having the filling factor of from 65 to 85% is manufactured by baking and carbonizing under a load of from 5 kPa to 3 MPa.

11. A manufacturing method of friction material, the method comprising:
preparing a mixture including an organic material, a metal, a lubricant, and an inorganic filler;
applying a load of from 5 kPa to 3 MPa to the mixture; and
baking and carbonizing the mixture under the load.

12. The manufacturing method according to claim 11, wherein the mixture is baked and carbonized in one of atmospheres of vacuum, reducing gas and inert gas.

13. The manufacturing method according to claim 11, wherein the mixture is baked and carbonized at a temperature of from 550° C. to 1300° C.

14. A friction material manufactured by the method according to claim 11.
